(19) United States
(12) Patent Application Publication
(10) Pub. No.: US 2023/0245638 A1
(43) Pub. Date: Aug. 3, 2023

(54) SYSTEM AND METHOD FOR OPTIMIZATION OF ACOUSTIC ECHO CANCELLATION CONVERGENCE

(71) Applicant: Shure Acquisition Holdings, Inc., Niles, IL (US)

(72) Inventors: Dusan Veselinovic, Chicago, IL (US); Bijal Joshi, Elk Grove Village, IL (US); Justin Joseph Sconza, Chicago, IL (US)

(21) Appl. No.: 18/160,058

(22) Filed: Jan. 26, 2023

Related U.S. Application Data
(60) Provisional application No. 63/304,286, filed on Jan. 28, 2022.

(51) Int. Cl. G10K 11/178

(52) U.S. Cl. CPC G10K 11/17823; G10K 11/17881; G10K 2210/505; G10K 2210/3027; G10K 2210/3031; G10K 2210/3011; G10K 11/17825; G10K 2210/3026; G10K 2210/3028; G10K 2210/30231; G10K 2210/12

(57) ABSTRACT

Embodiments include a method of reducing echo in an audio system comprising a microphone, an acoustic echo canceller (AEC), and at least one processor, the method comprising receiving, by the at least one processor, an audio signal detected by the microphone; deploying, by the at least one processor, a microphone lobe towards a first location associated with the detected audio signal; obtaining, by the at least one processor, one or more AEC parameters for the first location, the one or more AEC parameters being stored in a memory in communication with the at least one processor; initializing, by the at least one processor, the AEC using the one or more AEC parameters; and generating, by the at least one processor, an echo-cancelled output signal using the initialized AEC and based on the detected audio signal and a reference signal provided to the AEC.

### CROSS-REFERENCE

This application claims the benefit of U.S. Provisional Patent Application No. 63/304,286, filed on Jan. 28, 2022, the entirety of which is incorporated by reference herein.

### TECHNICAL FIELD

This disclosure generally relates to an acoustic echo cancellation (AEC) system. In particular, the disclosure relates to systems and methods for optimizing AEC convergence.

### BACKGROUND

Conferencing environments, such as conference rooms, boardrooms, video conferencing settings, and the like, typically involve the use of microphones (including microphone arrays) for capturing sound from various audio sources in the environment (also known as a “near end”) and loudspeakers for presenting audio from a remote location (also known as a “far end”). For example, persons in a conference room may be conducting a conference call with persons at a remote location. Typically, speech and sound from the conference room may be captured by microphones and transmitted to the remote location, while speech and sound from the remote location may be received and played on loudspeakers in the conference room. Multiple microphones may be used in order to optimally capture the speech and sound in the conference room.

In some cases, the microphones may pick up the speech and sound from the remote location that is played on the loudspeakers. In such situations, the audio transmitted to the remote location may include not only the speech and sound from the conference room (“local microphone signal”), but also the speech and sound from the remote location (“remote audio signal), thus creating an undesirable echo for the persons at the remote location who may be hearing their own speech and sound. If there is no correction, the audio transmitted to the remote location may be low quality or unacceptable because of this echo. Typical acoustic echo cancellation systems utilize an adaptive filter, e.g., a finite impulse response filter, on the remote audio signal to generate a filtered signal that can be subtracted from the local microphone signal to help remove any echo.

### SUMMARY

The techniques of this disclosure provide systems and methods designed to, among other things: (1) initialize an acoustic echo canceller (AEC) for a first microphone lobe using converged AEC parameters from a second microphone lobe that was previously deployed to the same or nearby location; (2) generate a database configured to store converged AEC parameters in association with corresponding location information; and (3) generate a map of a room or other environment to represent the locations at which various microphone lobes have been deployed in the room, and use the map to assign location information to the AEC parameter(s) corresponding to each microphone lobe.

One exemplary embodiment includes a method of reducing echo in an audio system comprising a microphone, an acoustic echo canceller (AEC), and at least one processor, the method comprising: receiving, by the at least one processor, an audio signal detected by the microphone; deploying, by the at least one processor, a microphone lobe towards a first location associated with the detected audio signal; obtaining, by the at least one processor, one or more AEC parameters for the first location, the one or more AEC parameters being stored in a memory in communication with the at least one processor; initializing, by the at least one processor, the AEC using the one or more AEC parameters; and generating, by the at least one processor, an echo-cancelled output signal using the initialized AEC and based on the detected audio signal and a reference signal provided to the AEC.

Another exemplary embodiment includes an audio system, comprising: a loudspeaker configured to play a far end audio signal received from a remote computing device; a microphone configured to detect a near end audio signal; an acoustic echo canceller (AEC) configured to receive the far end audio signal as a reference signal for estimating an echo in the near end audio signal; a memory configured to store a plurality of AEC parameters for configuring the AEC; and at least one processor in communication with the remote computing device and configured to: receive the near end audio signal from the microphone; deploy a microphone lobe towards a first location associated with the near end audio signal; obtain one or more AEC parameters for the first location; initialize the AEC using the one or more AEC parameters; and generate an echo-cancelled output signal using the initialized AEC and based on the near end audio signal and the reference signal.

Another exemplary embodiment includes a method of generating a database of acoustic echo cancellation (“AEC”) parameters for an environment, the method comprising: generating, by at least one processor, a map of the environment, the map comprising a plurality of location points; receiving, by the at least one processor, an AEC parameter associated with convergence of an acoustic echo canceller for a microphone lobe deployed to a first location; assigning, by the at least one processor, the AEC parameter to a select one of the plurality of location points based on the first location; and storing, in a memory, the AEC parameter in association with the assigned location point.

Another exemplary embodiments includes a method of generating a database of acoustic echo cancellation (“AEC”) parameters for an environment, the method comprising: receiving, by the at least one processor, an AEC parameter associated with convergence of an acoustic echo canceller for a microphone lobe deployed to a first location; receiving, by the at least one processor, location information indicating the first location; and storing, in a memory, the AEC parameter in association with the location information. According to one aspect, the method further comprises storing, in the memory, a convergence timestamp in association with the AEC parameter. According to some aspects, the AEC parameter includes a filter coefficient or a non-linear processing level. According to one aspect, the method further comprises selecting the plurality of location points based on one or more audio coverage areas associated with the environment.

Another exemplary embodiment includes a non-transitory computer-readable storage medium comprising instructions that, when executed by at least one processor, cause the at least one processor to perform: receiving an audio signal detected by a microphone; deploying a microphone lobe towards a first location associated with the detected audio signal; obtaining one or more AEC parameters for the first location, the one or more AEC parameters being stored in a memory in communication with the at least one processor; initializing an acoustic echo canceller (AEC) using the one or more AEC parameters; and generating an echo-cancelled output signal using the initialized AEC and based on the detected audio signal and a reference signal provided to the AEC.

Another exemplary embodiment includes a device comprising at least one processor configured to perform: receiving an audio signal detected by a microphone; deploying a microphone lobe towards a first location associated with the detected audio signal; obtaining one or more AEC parameters for the first location, the one or more AEC parameters being stored in a memory in communication with the at least one processor; initializing an acoustic echo canceller (“AEC”) using the one or more AEC parameters; and generating an echo-cancelled output signal using the initialized AEC and based on the detected audio signal and a reference signal provided to the AEC.

Another exemplary embodiment includes a method of reducing echo in an audio system comprising a microphone, an acoustic echo canceller (AEC), and at least one processor, the method comprising: receiving, by the at least one processor, an audio signal detected by the microphone; identifying a first location associated with the detected audio signal; obtaining, by the at least one processor, one or more AEC parameters for the first location, the one or more AEC parameters being stored in a memory in communication with the at least one processor; initializing, by the at least one processor, the AEC using the one or more AEC parameters; and generating, by the at least one processor, an echo-cancelled output signal using the initialized AEC and based on the detected audio signal and a reference signal provided to the AEC. According to aspects, obtaining one or more AEC parameters for the first location comprises: identifying a group of location points within an audio coverage area associated with the environment; determining a first location point within the group of location points that is closest to the first location; obtaining at least one AEC parameter associated with the first location point; and providing the at least one AEC parameter as the one or more AEC parameters for the first location.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of an exemplary audio system including an acoustic echo canceller, in accordance with one or more embodiments.

FIG. 2A is a schematic diagram of exemplary microphone lobes deployed by a microphone array of FIG. 1 in an environment, in accordance with one or more embodiments.

FIGS. 2B and 2C are schematic diagrams showing movement of a microphone lobe of FIG. 2 to a new location in the environment, in accordance with one or more embodiments.

FIG. 3 is a schematic diagram of an exemplary map for graphically representing the environment of FIG. 2, in accordance with one or more embodiments.

FIG. 4 is a flowchart illustrating operations for reducing echo in the audio system of FIG. 1, in accordance with one or more embodiments.

FIG. 5 is a block diagram of an exemplary computing device included in the audio system of FIG. 1, in accordance with one or more embodiments.

FIG. 6 is a schematic diagram of an exemplary map for graphically representing the environment of FIG. 2 and an audio coverage area associated with the environment, in accordance with one or more embodiments.

FIG. 7 is a schematic diagram of another exemplary map for graphically representing the environment of FIG. 2 and two audio coverage areas associated with the environment, in accordance with one or more embodiments.

### DETAILED DESCRIPTION

A typical acoustic echo canceller (AEC) includes an adaptive filter and a subtractor (or other summing component). The adaptive filter models an impulse response of a given environment, or the effects of certain components, like a loudspeaker, on the environment and based thereon, estimates an echo in a local microphone signal captured by a microphone in the environment. For example, the local microphone signal may include near-end audio or speech and other sounds produced by person(s) located in the environment, as well as far-end audio, or speech and other sounds produced by person(s) at a remote location (“remote audio signal”), which is broadcast over a loudspeaker in the environment. If the local microphone signal is transmitted to the remote location as is, the person(s) at the remote location will hear an echo (or linear echo). Using the remote audio signal as a reference signal, the AEC reduces or removes the echo in the local microphone signal before the signal is transmitted to the remote location. In particular, the subtractor subtracts an estimated echo signal, calculated by the adaptive filter based on the reference signal, from the local microphone signal to produce an echo-cancelled output signal. The echo-cancelled output signal is then provided to the remote location. The echo-cancelled output signal is also fed back into the adaptive filter and compared to the reference signal (or remote audio signal) to obtain an error signal. The echo in the remote audio signal may be considered reduced and/or removed (or cancelled) once the error signal calculated by the AEC is below a predetermined threshold (or nears zero).

When the AEC is first initiated for a given microphone lobe (also known as “initialization”), the AEC configures the adaptive filter using a preliminary set of parameters (e.g., filter coefficients, a non-linear processing (NLP) level, etc.) that are randomly selected, or otherwise pre-determined irrespective of the particular environment. As the reference signal changes, the AEC adapts the parameters of the adaptive filter accordingly, until the error signal is below the threshold. This scenario, or when an impulse response modeled by the adaptive filter closely approximates the actual impulse response of the environment, is known as “convergence” of the AEC. Until convergence is achieved, however, the person at the remote location may still detect an echo in the output signal and/or other audio artifacts. Accordingly, there is a need to improve AEC performance by increasing a speed of convergence of an AEC.

Systems and methods are provided herein for improving acoustic echo cancellation performance and more specifically, speeding up convergence of an acoustic echo canceller (AEC) for a microphone lobe deployed to a given location, by initializing the AEC using previously-converged parameters associated with the same or nearby location. Existing systems typically discard previously-converged AEC parameters once they are no longer being used, for example, due to a change in the lobe position and/or echo path, or any other change that renders the existing AEC parameters invalid. The techniques described herein recognize that a microphone lobe that is newly deployed to a given location is likely to have similar acoustic properties as a prior microphone lobe deployed to the same location, or to another nearby location. As a result, the AEC may be more quickly converged for the new microphone lobe if the AEC is initialized, or pre-populated, with the converged AEC parameters from the prior microphone lobe, rather than starting with a blank slate. Accordingly, the systems and methods described herein include storing the previously-converged AEC parameters in association with corresponding location information to enable automatic retrieval of appropriate parameters (e.g., based on proximity) when initializing the AEC for a new microphone lobe, thus reducing AEC convergence time and improving overall AEC performance.

In embodiments, the previously-converged AEC parameters may be stored in association with information about the corresponding microphone lobe, including the location of the lobe and in some cases, a directionality of the lobe, a width of the lobe, and/or others. For example, the converged AEC parameters and corresponding lobe information may be stored in a database to facilitate faster retrieval of location-appropriate parameters when deploying a new microphone lobe, or moving an existing lobe to a new location. During initialization of the AEC for the new microphone lobe, one or more previously-converged AEC parameters may be retrieved from the database based on the intended location of the new microphone lobe. If the exact location is not included in the database, a nearest location within the database may be determined, and the previously-converged AEC parameters corresponding to the nearest location may retrieved. The retrieved parameters may be applied to the adaptive filter and/or other component of the AEC to complete initialization.

In some embodiments, the audio system includes a room mapping tool (or “room mapper”) configured to generate a map, or grid, of the room or other environment for representing the locations at which various microphone lobes have been previously deployed in the room. For example, the grid may be used to assign a point on the grid to each previously-converged AEC parameter, and each assigned grid point may be stored in the AEC parameter database as the location information for the corresponding AEC parameter. In some cases, each AEC parameter is also stored in association with a timestamp that indicates the time of convergence for that parameter, for example, so that only the most recent AEC parameters are used for initialization of the AEC. In some embodiments, the database may be continuously updated each time a new microphone lobe is deployed, for example, by storing any newly converged AEC parameters in the database in association with the corresponding location information (e.g., grid point) and timestamp.

As used herein, the terms “lobe” and “microphone lobe” refer to an audio beam generated by a given microphone array (or array microphone) to pick up audio signals at a select location, such as the location towards which the lobe is directed. While the techniques disclosed herein are described with reference to microphone lobes generated by array microphones, in some cases, the same or similar techniques may be utilized with other forms or types of microphone coverage (e.g., a cardioid pattern, etc.) and/or with microphones that are not array microphones (e.g., a handheld microphone, boundary microphone, lavalier microphones, etc.). Thus, the term “lobe” is intended to cover any type of audio beam or coverage.

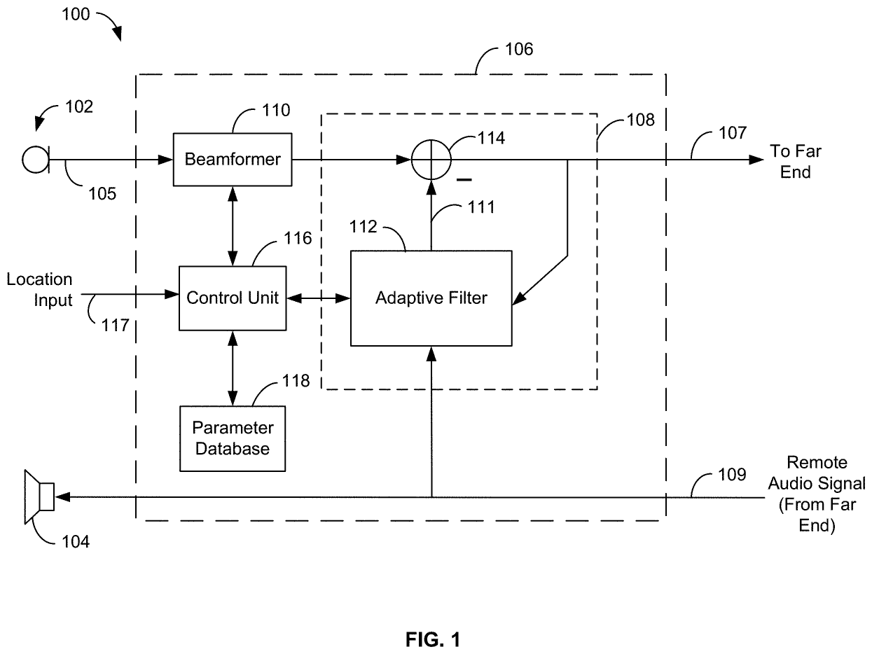

Referring now to FIG. 1, shown is a schematic diagram of an audio system 100 comprising a microphone 102 for capturing sounds from one or more audio sources in an environment and a loudspeaker 104 for presenting audio from a remote location, in accordance with embodiments. The audio system 100 further comprises a computing device 106 communicatively coupled to the microphone 102, the loudspeaker 104, and the remote location (or a remote computing device located at the remote location). The computing device 106 comprises an acoustic echo cancellation system 108 (also referred to herein as an “acoustic echo canceller” or “AEC”) configured to receive an audio signal 105 from the microphone 102 and generate an echo-cancelled output signal 107 based on the received audio signal and a reference signal 109 from the remote location (also referred to here as “remote audio signal”). The echo-cancelled output signal 107 may mitigate the sound received from the remote location and played on the loudspeaker 104 (or the remote audio signal 109) and more specifically, mitigate linear echo, and in some cases, residual echo, that is detected by the microphone 102. In this way, the echo-cancelled output signal 107 can be transmitted to the remote location without the undesirable echo of persons at the remote location hearing their own speech and sound.

As will be appreciated, various components included in the audio system 100 may be implemented using software executable by one or more servers or computers, such as the computing device 106 and/or other computing device with a processor and memory (e.g., device 500 shown in FIG. 5), and/or by hardware (e.g., discrete logic circuits, application specific integrated circuits (ASIC), programmable gate arrays (PGA), field programmable gate arrays (FPGA), etc.

Environments such as conference rooms may utilize the audio system 100 (also referred to as a “communication system”) to facilitate communication with persons at the remote location, for example. The type of microphone 102 and its placement in a particular environment may depend on the locations of audio sources, physical space requirements, aesthetics, room layout, and/or other considerations. For example, in some environments, the microphone 102 may be placed on a table or lectern near the audio source. In other environments, the microphone 102 may be mounted overhead to capture the sound from the entire room, for example. The audio system 100 may work in conjunction with any type and any number of microphones 102, including one or more microphone transducers (or elements), a microphone array, or other audio input device capable of capturing speech and other sounds. As an example, the microphone 102 may include, but is not limited to, SHURE MXA310, MX690, MXA910, and the like.

Loudspeaker 104 may be any type of audio speaker, speaker system, or other audio output device for audibly playing audio signals received from the remote location, such as remote audio signal 109 (also referred to herein as “far end audio signal”), or other sounds associated with the communication event. As an example, the loudspeaker 104 may include, but is not limited to, SHURE MXN5W-C and the like.

Computing device 106 may be configured to enable a conferencing call or otherwise implement one or more aspects of the communication between the audio system 100 and the remote location. The computing device 106 can be any generic computing device comprising at least one processor and a memory device (such as, e.g., computing device 500 as shown in FIG. 5). In some embodiments, the computing device 106 may be a standalone device that is communicatively coupled to each of the microphone 102, the loudspeaker 104, and the remote location using a wired connection (e.g., Ethernet cable, USB cable, etc.) or a wireless network connection (e.g., WiFi, Bluetooth, Near Field Communication (“NFC”), RFID, infrared, etc.). For example, in some cases, one or more of the microphone 102 and the loudspeaker 104 may be network audio devices coupled to the computing device 106 via a network cable (e.g., Ethernet) and configured to handle digital audio signals. In other cases, the audio devices may be analog audio devices or another type of digital audio device and may be connected to the computing device 106 using a Universal Serial Bus (USB) cable or other suitable connection mechanism. In other embodiments, the computing device 106 may include the microphone 102, or may be included in the same housing as the microphone 102. Similarly, in some embodiments, the computing device 106 may include the loudspeaker 104, or may be included in the same housing as the loudspeaker 104. Though FIG. 1 shows the audio system 100 as including a single computing device 106, in other embodiments, the audio system 100 may include two or more computing devices 106 that are communicatively coupled to each other and/or other components of the system 100, for example using wired and/or wireless connections.

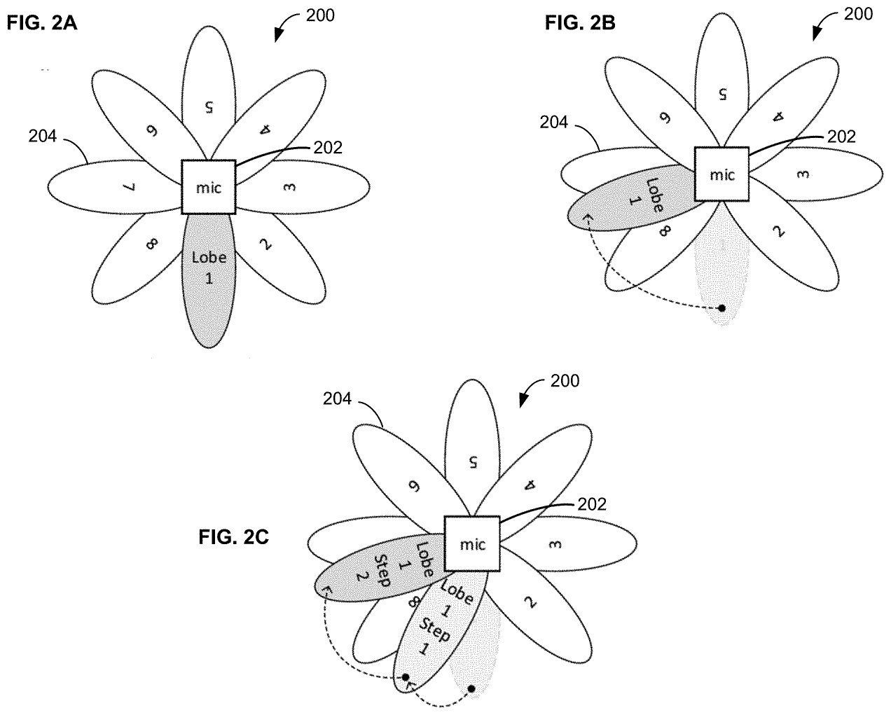

Microphone 102 can be configured to detect sound in the environment and convert the sound to an audio signal 105 (also referred to herein as “local microphone signal”). In some embodiments, the audio signal 105 detected by the microphone 102 may be processed by a beamformer 110 to generate one or more beamformed audio signals, or otherwise direct an audio pick-up beam, or microphone lobe, towards a particular location in the environment (e.g., as shown in FIG. 2A). In other embodiments, the audio system 100 may not include the beamformer 110, in which case the detected audio signal 105 may be provided to the AEC 108 directly, or without processing. For example, the microphone 102 may be an omnidirectional microphone configured to capture audio signals using an omnidirectional lobe. In some embodiments, the microphone 102 may be configured to use a general or non-directional lobe to detect audio, and upon detecting an audio signal at a given location, the microphone 102 and/or the beamformer 110 may deploy a directed lobe towards the given location for capturing the detected audio signal. For ease of explanation, the techniques described herein may refer to using the audio signal 105 from the microphone 102, even though the techniques may utilize any type of acoustic source, including beamformed audio signals generated by the beamformer 110. In addition or alternatively, the audio signal 105 from the microphone 102 and the remote audio signal 109 from the remote location may be converted into the frequency domain, in which case, the acoustic echo canceller 108 may operate in the frequency domain.

While FIG. 1 shows the beamformer 110 as included within the computing device 106, in other embodiments, the beamformer 110 may be included in one or more other components of the audio system 100, such as, for example, the microphone 102, or otherwise included in a standalone device outside the computing device 106. In some embodiments, the beamformer 110 may be included in, or combined with, the AEC 108, control unit 116, or other component of the computing device 106.

The remote audio signal 109 received from the remote location may be provided not only to the loudspeaker 104, but also to the acoustic echo canceller (AEC) 108 as a reference signal. As shown in FIG. 1, the acoustic echo canceller 108 includes an adaptive filter 112 and a summing component 114 (e.g., subtractor or adder). The adaptive filter 112 is configured to process the remote audio signal 109 and generate a filtered remote audio signal 111 (also referred to as an “echo estimation signal”), which is an estimate of the acoustic path of the remote audio signal 109, or a model of the echo that will be detected by the microphone 102. In embodiments, the adaptive filter 112 may be a finite impulse response filter, or any other appropriate type of filter. As shown in FIG. 1, the filtered remote audio signal 111 may be subtracted from the audio signal 105 of the microphone 102 using the summing component 114 to generate the echo-cancelled output signal 107. In this manner, any linear echo in the local microphone signal 105 may be reduced or removed from the echo-cancelled output signal 107.

In embodiments, the AEC 108 can be configured to continuously improve the echo-cancelled output signal 107 until convergence is achieved for the corresponding microphone lobe, or said differently, until the echo path modeled by the adaptive filter 112 (e.g., filtered remote audio signal 111) closely approximates the actual echo in the environment. The AEC 108 may improve the output signal 107 by dynamically adjusting one or more parameters, such as, for example, a least means square (“LMS”) coefficient, normalized LMS coefficient (“NLMS”), recursive least squares coefficient (“RLS”), and/or other filter coefficient for the adaptive filter 112 or other component, parameters of another gradient-descent based algorithm, delay values applied to the adaptive filter 112, or any combination thereof (e.g., coefficient-delay pairings or “taps”), a non-linear processing (“NLP”) level (e.g., none, low, medium, high, etc.) or other attenuation level applied to the output of the adaptive filter 112 to suppress the echo, and/or other AEC parameters.

More specifically, the AEC 108 may be configured to identify an error level in the echo-cancelled output signal 107 and adapt one or more parameters of the AEC 108 until the error level is below a predetermined threshold (or zero). For example, as shown in FIG. 1, the echo-cancelled output signal 107 may be fed or provided back into the adaptive filter 112, and the adaptive filter 112 may be configured to compare the echo-cancelled output signal 107 to the reference signal, or remote audio signal 109, and calculate an error signal (or error level) based thereon. If the echo-cancelled output signal 107 still includes an echo of the remote audio signal 109, the error signal will be high, or above the predetermined threshold. In such cases, the adaptive filter 112 may adjust one or more filter coefficients and/or other parameters of the AEC 108 accordingly, and may keep doing so, incrementally, until the error signal is low, or below the predetermined threshold, and/or the error signal is constant or unchanged for a threshold amount of time. In some cases, once the echo has been largely removed, or cancelled, the adaptive filter 112 may determine that convergence is achieved and may stop adapting the parameters of the AEC 108 for the corresponding microphone lobe. The parameters of the AEC 108 at the time of reaching convergence are referred to as the “converged AEC parameters” for that microphone lobe. In other cases, the adaptive filter 112 may continuously adapt the AEC parameters based on newly-received or incoming audio data for the corresponding microphone lobe. In such cases, the “converged AEC parameters” may continuously or periodically change over time, as updates occur.

As shown in FIG. 1, the computing device 106 may further include a control unit 116 and a parameter database 118. According to embodiments, the control unit 116 may be configured to collect or obtain converged AEC parameters from the AEC 108, obtain information about the microphone lobe that corresponds to the converged AEC parameters, including location information indicating a location of the microphone lobe, and provide the converged AEC parameters and corresponding lobe information to the parameter database 118. The database 118 may be configured to store the previously-converged AEC parameters in association with the corresponding lobe information, as further described herein. During initialization of the AEC 108 for a new microphone lobe that has been deployed to a given location, the control unit 116 may be further configured to retrieve, from the database 118, a set of previously-converged AEC parameters based on the location of the new microphone lobe, and provide the retrieved AEC parameters to the AEC 108. The AEC 108 may use the previously-converged AEC parameters to initialize, or pre-populate, the adaptive filter 112 and/or other components of the AEC 108, so that faster AEC convergence is achieved for the new microphone lobe, as further described herein.

In various embodiments, the control unit 116 may be a controller or other suitable control device and may include a processor and memory configured to carry out instructions and/or commands in accordance with the techniques described herein. The parameter database 118 may be stored in a memory of the computing device 106 or other memory of the audio system 100. In some embodiments, the information stored in the database 118 may be compressed, for example, using known techniques, in order to reduce the amount of memory occupied by the database 118. While FIG. 1 shows the control unit 116 and the parameter database 118 as being included in the computing device 106, in other embodiments, the control unit 116 and/or the parameter database 118 may be included in one or more other components of the audio system 100, or otherwise included outside of the computing device 106. In some embodiments, the control unit 116 and/or the parameter database 118 may be combined with one or more other components of the computing device 106, such as, for example, the AEC 108 or the beamformer 110.

In embodiments, the control unit 116 may be configured to monitor a convergence status of the AEC 108. Once the adaptive filter 112 provides or reports a “converged” status, or the control unit 116 otherwise determines that the AEC 108 has achieved convergence for a given microphone lobe, the control unit 116 may be configured to request or obtain the AEC parameters that were used to achieve convergence for the given microphone lobe. The converged AEC parameters received at the control unit 116 may include, for example, the filter coefficients and/or taps applied to the adaptive filter 112, the NLP level applied to the output of the filter 112, and/or any other characteristics of the AEC 108 that are relevant to achieving convergence. In some cases, the control unit 116 may also receive, from the AEC 108, other information about the corresponding microphone lobe, such as, for example, a directionality of the microphone lobe, lobe width information, identifying information associated with the lobe (e.g., a lobe identifier, numerical label, or other code), and more.

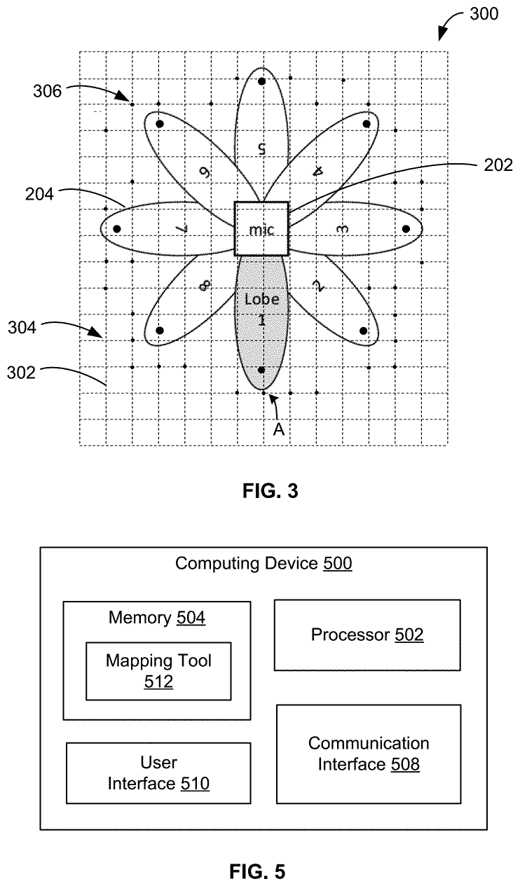

In some embodiments, the control unit 116 may be configured to receive a location input 117 that comprises location information for the microphone lobe that corresponds to the converged AEC parameters. In some cases, the location input 117 may be provided or transmitted to the control unit 116 by the microphone 102 or other component of the audio system 100 that is outside the computing device 106, for example, as shown in FIG. 1. In other cases, the control unit 116 may be configured to receive the location information for a given lobe from the beamformer 110, or other component of the computing device 106. In still other embodiments, lobe location information may be determined by the control unit 116, itself, for example, using a mapping tool (e.g., mapping tool 512 shown in FIG. 5), as described herein with respect to FIG. 3.

In some embodiments, the location information included in the location input 117, or otherwise, may include location coordinates for a center of the corresponding microphone lobe, the location to which the microphone lobe was deployed by the microphone 102, or other location associated with the microphone lobe. The location coordinates may be relative to a center of the microphone 102 or otherwise included in a coordinate system of the microphone 102. In some cases, the location coordinates may be Cartesian or rectangular coordinates that represent a location point in three dimensions, or x, y, and z values. In other cases, the location coordinates may be polar or spherical coordinates, i.e. azimuth (phi), elevation (theta), and radius (r), which may be obtained from the Cartesian coordinates using a transformation formula, as is known in the art. In various embodiments, the location coordinates may be generated by a localization software or other algorithm included in the microphone 102 or other component of the audio system 100. For example, the localization software in the microphone 102 may be configured to generate a localization of a detected sound, or other audio source, and determine coordinates that represent a location or position of the detected audio source relative to the microphone 102 (or microphone array). These location coordinates may be provided to the control unit 116 as the location input 117. Various methods for generating sound localizations are known in the art, including, for example, generalized cross-correlation (“GCC”) and others.

Referring additionally to FIGS. 2A to 2C, in embodiments that include the beamformer 110, the microphone 102 may be configured to point or direct a plurality of microphone lobes towards various locations, or at various angles relative to the microphone 102. For example, FIG. 2A shows an environment 200 comprising an exemplary microphone array 202 with eight microphone lobes 204 deployed substantially equidistantly around the microphone array 202 in order to capture audio signals at various locations in the environment 200. In embodiments, the microphone array 202 may be the same as, or substantially similar to, the microphone 102 of FIG. 1 and may be included in the audio system 100.

In some embodiments, the number of lobes 204 may be fixed at eight, or other number (e.g., six, four, etc.). In other embodiments, the number of lobes 204 may be selectable by a user and/or automatically determined based on the locations of the various audio sources detected by the microphone array 202. Similarly, in some embodiments, a directionality and/or location of each lobe 204 may be fixed, such that the lobes 204 always form a specific configuration (e.g., the “flower pattern” shown in FIG. 2A). In other embodiments, the directionality and/or location of each lobe 204 may be adjustable or selectable based on a user input (e.g., as shown in FIGS. 2B and 2C) and/or automatically in response to, for example, detecting a new audio source or movement of a known audio source to a new location, or based on other data from other sensors (e.g., a non-audio sensor, etc.).

More specifically, in various embodiments, the microphone array 202, the beamformer 110, and/or other component of the audio system 100 (e.g., the computing device 106) may be configured to automatically place or deploy a select one of the microphone lobes 204 based on a directionality of the audio signal detected by the microphone array (e.g., audio signal 105 in FIG. 1), for example, using an automatic lobe deployment (“ALD”) algorithm, or the like. In some embodiments, the audio system 100 and/or the computing device 106 may further include graphical user interface (“GUI”) or other user input device (not shown) configured to enable a user to select any one of the deployed lobes 204 and move the selected lobe 204 to a new location, including, for example, moving an existing lobe to a new location or placing a new microphone lobe anywhere in the room.

For example, FIGS. 2B and 2C show the Lobe 1 being moved to a new location between Lobe 7 and Lobe 8. In FIG. 2B, Lobe 1 is moved to the new location in a one-step process. In embodiments, the one-step process may be used when the lobe movement is initiated by the ALD or other algorithm of the audio system 100, or when the new location for Lobe 1 is manually entered by the user, e.g., using the GUI, as a set of coordinates or other location information for indicating the location between Lobe 7 and Lobe 8. In FIG. 2C, Lobe 1 is moved to the new location in a two-step process, wherein step 1 includes moving Lobe 1 to an intermediary location between Lobe 8 and the original location of Lobe 1, and step 2 includes moving Lobe 1 from the intermediary location to the final or intended location between Lobe 7 and Lobe 8. In embodiments, the two-step process may be used when the user manually moves (or drags) Lobe 1 to the new location on the GUI, for example, using a mouse or touchscreen. In such cases, the GUI may be configured to process the user-led movement of Lobe 1 in lockstep movements of the given microphone lobe 204 from one designated lobe location to the next, thus requiring Lobe 1 to be moved in two steps as shown in FIG. 2C.

Referring back to FIG. 1, regardless of which technique is used to move Lobe 1 in the illustrated examples, upon receiving an input to move an existing microphone lobe to a new location, or location coordinates corresponding to the new location of the lobe, the computing device 106 and/or the control unit 116 may re-initialize the AEC 108 for the newly-moved microphone using the above described techniques. For example, the control unit 116 may identify a previous lobe location that is stored in the parameter database 118 and is the same as or closest to the new lobe location (e.g., using Euclidean distance calculation, or others), and may retrieve, from the database 118, the converged AEC parameters associated with that previous lobe location. For example, in FIG. 2B, the control unit 116 may determine that the parameter database 118 includes converged AEC parameters for Lobe 7 and that the location of Lobe 7 is closest to the new location of Lobe 1. Accordingly, the control unit 116 may retrieve the converged AEC parameters for Lobe 7 from the database 118 and initialize the AEC 108 using the retrieved parameters. For example, the AEC 108 may apply the retrieved AEC parameters for Lobe 7 to the adaptive filter 112 and/or other components of the AEC 108, thus resulting in faster convergence of the AEC 108 for the newly-located Lobe 1.

In embodiments where movement of a microphone lobe involves a two-step process as shown in FIG. 2C, the initialization of the AEC 108 may also occur in a two steps. For example, in FIG. 2C, the control unit 116 may first retrieve the converged AEC parameters for Lobe 8 from the parameter database 118, after determining that the intermediate location of Lobe 1 is closest to the location of Lobe 8. Accordingly, the AEC 108 may first be initialized using the converged parameters for Lobe 8. Meanwhile, Lobe 1 may continue the journey to its intended location by moving from the intermediate location to the final location. Once Lobe 1 is at the final location, the control unit 116 may determine that the location of Lobe 7 is now closest to the final location. Accordingly, the control unit 116 may retrieve the converged AEC parameters for Lobe 7 from the parameter database 118 and re-initialize the AEC 108 using the Lobe 7 parameters, or otherwise apply the Lobe 7 parameters to the AEC 108. Thus, during the two-step process, the AEC 108 may be initialized twice, or incrementally, using two different sets of filter coefficients (or taps).

Referring back to FIG. 1, as described herein, the control unit 116 may be configured to store the converged AEC parameters determined for a given microphone lobe in the parameter database 118 in association with the location information received for that microphone lobe (e.g., via the location input 117). In some embodiments, the control unit 116 is also configured to store a timestamp, or other timing information, in association with each AEC parameter in the parameter database 118. The timestamp (also referred to as “convergence timestamp”) may indicate the time at which AEC convergence was achieved using the corresponding AEC parameter, or the time at which the AEC parameter was received at the control unit 116 and/or the parameter database 118 (e.g., post convergence). The timestamp enables the control unit 116 to identify the most recent, or “freshest,” AEC parameters in the parameter database 118 when retrieving converged AEC parameters for a new microphone lobe. In some embodiments, the control unit 116 may use the timing information to remove “stale” or older entries from the database 118, such as, for example, any convergence parameters that have been in the database 118 for longer than a threshold amount of time.

In various embodiments, the control unit 116 and/or the computing device 106 may be configured to populate the parameter database 118 over time, or dynamically during normal use of the audio system 100. For example, the control unit 116 may be configured to store the corresponding AEC parameters in the database 118 each time the AEC 108 is converged for a new microphone lobe during a communication event. In such cases, the database 118 may be generated based on historical information, and the location information may be received at the control unit 116 in the form of the location input 117, or other input, from one or more components of the audio system 100, as described herein.

Alternatively, or additionally, the control unit 116 and/or the computing device 106 may be configured to generate or build the parameter database 118 during an initial set up phase of the audio system 100, or otherwise prior to normal use of the audio system 100. For example, the control unit 116 and/or the computing device 106 may be configured to play a test signal (e.g., pink noise, white noise, etc.) over the loudspeaker 104 or other audio output device in the environment. The microphone 102 may detect the test signal as coming from a given location (e.g., the location of the loudspeaker 104) and deploy a microphone lobe towards that location. The control unit 116 may initialize the AEC 108 for the microphone lobe using known (e.g., default or generic) parameters, and once convergence is achieved, store the converged AEC parameters in the database 118 in association with the location of that microphone lobe. The test signal may be played again and again at various locations around the room or other environment, for example, either at random or at predetermined locations in the room, until the parameter database 118 includes, or is populated with, a sufficiently diverse collection of microphone lobes or otherwise meets a minimum requirement for setting up the database 118 (e.g., minimum number of database entries, database entries corresponding to each corner of the room and/or anticipated lobe locations, etc.).

In some embodiments, the audio system 100 and/or the computing device 106 may include a mapping tool (such as, e.g., mapping tool 512 shown in FIG. 5) that is configured to generate a map, grid, or other graphical representation of the room or environment in which the audio system 100 is located. The mapping tool may be a software application stored in a memory of the audio system 100, such as, for example, a memory of the computing device 106 and/or the control unit 116. The map generated by the mapping tool (or “room mapper”) may be used to represent the locations at which the various microphone lobes are deployed in the room, for example, during the set-up phase for building the parameter database 118 and/or to otherwise assign location information to each microphone lobe. For example, during the initial set-up phase, the test signal may be played at each of a plurality of location points included in the map, a separate microphone lobe may be deployed to each location point, and the parameters for achieving AEC convergence for each of the microphone lobes may be recorded in the parameter database 118 in association with the coordinates for the corresponding location point. As another example, during the normal use phase, the control unit 116 may use the map generated by the mapping tool to assign a corresponding location point to each microphone lobe, for example, based on the location input 117 received for that lobe, and store the assigned location point in the parameter database 118 in association with the converged AEC parameters for that lobe. In this manner, the mapping tool may be used to provide a unified format for the location information that is stored in the database 118, which enables faster comparison of lobe locations to identify the closest prior lobe and thus, faster retrieval of appropriate AEC parameters for a newly-deployed microphone lobe.

FIG. 3 illustrates an exemplary map or grid 300 generated by the mapping tool of the audio system 100 for graphically representing the environment 200 in which the plurality of microphone lobes 204 are deployed by the microphone array 202. The illustrated grid 300 comprises a plurality of grid lines 302 arranged at equal distances from each other, both vertically and horizontally. In some embodiments, each intersection of two grid lines 302 may be considered a grid point 304 (or location point). In such cases, each grid point 304 may be represented by an integer number of delta-x and delta-y, or coordinates relative to a central point (0,0) of the grid 300. In other embodiments, any location on the grid 300 may be considered a grid point 304, including locations that are not positioned on one of the grid lines 302. In such cases, each grid point 304 may be represented by a non-integer number of delta-x and delta-y, or other coordinates relative to the central point of the grid 300.

In FIG. 3, a plurality of known or prior lobe locations 306 are graphically represented, or plotted, on the grid 300 by placing a plot point, or graphical indicator, at the assigned grid point 304. The prior lobe locations 306 may represent the locations of microphone lobes that were deployed in response to test signals played during setup of the audio system 100 and/or the locations of microphone lobes that were deployed in response to detecting an audio signal during normal use of the audio system 100. In either case, the control unit 116 may assign a corresponding grid point 304 to each microphone lobe based on the location of the lobe, and stored the assigned grid point 304 in the parameter database 118 as the location information for that lobe.

In embodiments, when a new microphone lobe 204 is deployed, the microphone lobe 204 may be plotted on the grid 300 (e.g., Lobe 1 in FIG. 3), and the control unit 116 may use the grid 300 to quickly identify the prior lobe location 306 that is co-located with, or closest to, the new microphone lobe 204. For example, in FIG. 3, the control unit 116 may identify point A of the prior lobe locations 306 as being closest to Lobe 1, for example, by comparing the proximity of each nearby location 306 to the center of Lobe 1 (e.g., using Euclidean distance calculations, or the like). Upon identifying point A as the closest lobe location, the control unit 116 may retrieve the converged AEC parameters corresponding to point A from the parameter database 118 and use the retrieved parameters to initialize the AEC 108 for Lobe 1. Once AEC convergence is achieved for Lobe 1, the control unit 116 may store the newly converged AEC parameters for Lobe 1 in the database 118 in association with the coordinates for the point 304 on the grid 300 that corresponds to the location of Lobe 1. In some cases, the corresponding grid point 304 may also be plotted, or highlighted, on the grid 300 as a prior lobe location 306, so that the grid 300 remains up to date.

While FIG. 3 shows a rectangular grid with equidistant points that are associated with Cartesian coordinates, in other embodiments, the mapping tool may be configured to generate a map that is tied to spherical coordinates, for example, where the location points are at equidistant azimuth or elevation angles (e.g., located at five or ten degree intervals, etc.). In such cases, each grid point may be represented by polar coordinates (e.g., azimuth, elevation, and/or radius values). In still other embodiments, the mapping tool may be configured to generate a map that is a non-linear grid and/or has non-equidistant location points. Also, while FIG. 3 shows a two-dimensional grid, in other embodiments, the map tool may be configured to generate a three-dimensional grid for representing the entire room or environment. In such cases, each grid point may be represented by three-dimensional coordinates, e.g., x, y, and z values, or azimuth, elevation, and radius values, depending on the type of grid. Regardless of the type of map generated by the mapping tool, the control unit 116 can be configured to use the map to assign location information (e.g., coordinates) to each of the microphone lobes deployed in the room and the converged AEC parameters associated therewith.

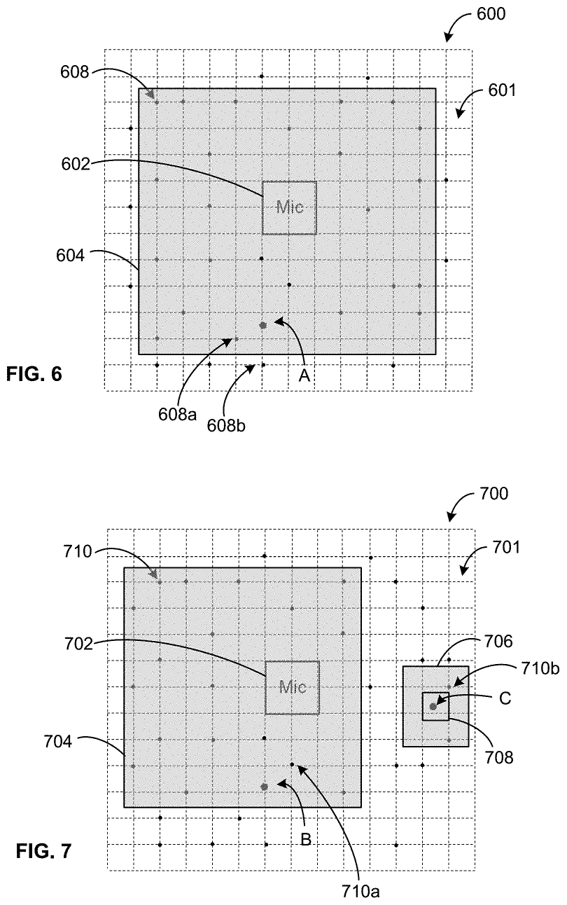

Various embodiments describe using prior microphone lobe locations to identify appropriate converged AEC parameters for a new talker location, for example, as shown in FIG. 3. In other embodiments, the mapping tool may be configured to display one or more audio coverage areas on the map, instead of, or in addition to, the microphone lobes, and the control unit 116 may be configured to use the one or more audio coverage area(s) to define or limit the locations, or location points, that are available for matching to a new talker location for AEC convergence purposes, for example, as shown in FIGS. 6 and 7 and described below. In such cases, the mapping tool may be configured to plot on the map (or grid) location points that correspond to prior audio pick-up locations, which may include the prior lobe locations and/or other beamformed locations.

More specifically, audio coverage areas may be defined as regions designated within the environment for capturing audio signals, such as, e.g., speech produced by human speakers. In some cases, the audio coverage areas (or “audio pick-up regions”) may designate or delineate the spaces within which lobes can be deployed by the microphones, other beamforming techniques can be focused for audio pick-up, or audio can otherwise be captured by the microphones. Conversely, the areas outside the audio coverage area(s) may correspond to the spaces where audio capture will be rejected or avoided by the microphones. The exact number, size, and shape of the audio coverage area(s) may vary depending on the size, shape, and type of environment, for example.

For example, FIG. 6 shows a map 600 of an exemplary environment 601 comprising a microphone 602 (e.g., microphone array) and a single audio coverage area 604, in accordance with embodiments. The single audio coverage area may be located at or near a podium, display area (e.g., whiteboard, projector screen, etc.), or the front of the room to capture a presenter's speech, designated around a conference table to capture human speakers seated at the table, or otherwise delineating a specific region for audio pick-up. In the illustrated embodiment, the audio coverage area 604 is located around, or generally centered on, the microphone 602 and is configured to provide audio coverage for a substantial portion of the environment 601, for example, by extending close to the edges of the environment 601.

As another example, FIG. 7 depicts a map 700 of an exemplary environment 701 comprising a microphone 702, a first audio coverage area 704 that is located around and/or overlaps the microphone 702, and a second audio coverage area 706 that is located around and/or overlaps a podium 708 disposed in the environment 701, in accordance with embodiments. Multiple audio coverage areas may be distributed throughout a given environment, for example, at or near each seating area in the room to capture human speakers in different areas of the room, at distinct locations configured to avoid known noise sources, or to otherwise delineate multiple regions for audio pick-up. While the illustrated embodiment shows the first audio coverage area 704 and the second audio coverage area 706 as being separated from each other by a certain distance, in other embodiments, two or more audio coverage areas may be disposed adjacent to each other, so that they share a boundary, for example.

In various embodiments, the mapping tool and/or the control unit 116 can be configured to select, or limit, the plurality of location points that are available for matching to a newly-detected talker location based on the one or more audio coverage areas associated with the environment (e.g., room). For example, in FIG. 6, the map 600 includes a plurality of location points 608 that represent previously-stored (or prior) audio pick-up locations that have converged AEC parameters stored in an AEC parameter database (e.g., database 118 of FIG. 1). That is, at some point in the past, one or more beamforming techniques were focused towards each location point 608 in order to pick-up or capture audio from a talker or other audio source located at the point 608. As shown, the location points 608 are distributed throughout the environment 601, including both inside and outside the single audio coverage area 604. Upon receipt of a new talker location, A (e.g., via location input 117 in FIG. 1), the control unit 116 may be configured to select a given location point 608 that is within the boundaries of the audio coverage area 604 and is closest to talker location A. As shown in FIG. 6, the new talker location A is approximately equidistant from two location points 608a and 608b. However, location point 608b is outside the audio coverage area 604 and thus, removed from consideration. Accordingly, the control unit 116 selects location point 608a as the closest prior location and uses the previously-converged AEC parameters associated with location point 608a to initialize the AEC for the new talker location A.

As another example, in FIG. 7, the map 700 includes a plurality of location points 710 that represent previously-stored audio pick-up locations with converged AEC parameters stored in a parameter database. The location points 710 are distributed throughout the environment 701, including inside the first audio coverage area 704, inside the second audio coverage area 706, and outside both coverage areas. Upon receipt of a new talker location, B, that is within the first audio coverage area 704, the control unit 116 may be configured to compare location B to a first subset of the location points 710, the first subset including the location points 710 that are within the first audio coverage area 704, and select a location point 710a from the first subset as being the closest location point 710 to new talker location B. Likewise, upon receipt of a new talker location, C, that is within the second audio coverage area 706, the control unit 116 may be configured to compare location C to a second subset of the location points 710, the second subset including the location points 710 that are within the second audio coverage area 706, and select a location point 710b from the second subset as being the closest location point 710 to new talker location C.

In some embodiments, the mapping tool can be further configured to ensure that only the location points within the audio coverage area(s) are available for matching to incoming talker locations and that audio from outside the audio coverage area(s) is rejected. For example, the mapping tool may be configured to select the plurality of location points 608 or 710 based on the audio coverage areas, so that the map only displays those prior audio pick-up locations that are within the audio coverage area(s) associated with the given environment, instead of displaying all known location points as illustrated. In some embodiments, the parameter database 118 may also be configured to limit the pool of available location points, for example, by storing only those location points that are within the regions of the environment covered by audio coverage areas and thus, speed up data processing and retrieval times.

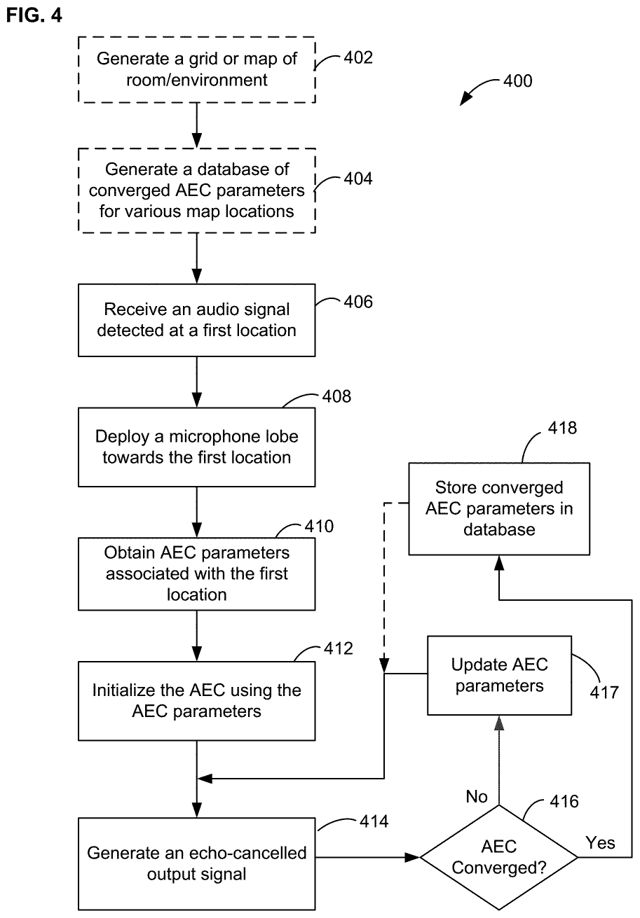

Referring now to FIG. 4, shown is an exemplary method or process 400 for reducing an echo in an audio system, or more specifically, in an audio signal provided to a remote location by the audio system, the audio system comprising a microphone, an acoustic echo canceller (“AEC”), and at least one processor. In embodiments, the audio system may be the audio system 100 shown in FIG. 1 or substantially similar thereto. Accordingly, for ease of explanation, the process 400 will be described below with reference to the audio system 100 of FIG. 1, though it should be appreciated that the process 400 may also be implemented using other audio systems or devices. In embodiments, one or more processors and/or other processing components within the audio system 100 may perform any, some, or all of the steps of the process 400. In particular, the process 400 may be carried out by the computing device 106, or more specifically a processor of said computing device (e.g., processor 502 of FIG. 5) executing software stored in a memory (e.g., memory 504 of FIG. 5). In some cases, the computing device 106 may further carry out the operations of process 400 by interacting or interfacing with one or more other devices that are internal or external to the audio system 100 and communicatively coupled to the computing device 106 (e.g., the remote location, microphone 102, loudspeaker 104, etc.). One or more other types of components (e.g., memory, input and/or output devices, transmitters, receivers, buffers, drivers, discrete components, etc.) may also be utilized in conjunction with the processors and/or other processing components to perform any, some, or all of the steps of the process 400.

As shown in FIG. 4, in some embodiments, the process 400 begins at step 402 with generating, by at least one processor, a map, grid, or other graphical representation of an environment comprising the audio system, such as, for example, grid 300 shown in FIG. 3. The map may comprise a plurality of location points for representing different locations in the environment. In some embodiments, step 402 further comprises selecting the plurality of location points displayed on the map based on one or more audio coverage areas associated with the environment, as described herein. For example, only the location points that correspond to, or fall within, the one or more audio coverage areas may be provided on the map, or otherwise eligible for selection when using the map (e.g., for assignment to a converged AEC parameter, etc.). In various embodiments, the at least one processor (or control unit 116 of FIG. 1) may use a mapping tool (e.g., mapping tool 512 of FIG. 5) to generate the map of the environment, as described herein.

Process 400 may further include, at step 404, generating, by the at least one processor, a database (e.g., parameter database 118 of FIG. 1) of converged acoustic echo cancellation (“AEC”) parameters corresponding to various locations on the map, such as, for example, the locations to which microphone lobes were previously deployed, prior talker locations, and/or locations that fall within the audio coverage area(s) associated with the environment. The database may be stored in a memory (e.g., memory 504 of FIG. 5) that is in communication with the at least one processor.

In various embodiments, generating the database at step 404 may include receiving a plurality of AEC parameters (or converged AEC parameters), each AEC parameter associated with convergence of the AEC (e.g., AEC 108 of FIG. 1) for a select one of a plurality of microphone lobes, and receiving location information for each of the plurality of microphone lobes. For example, the converged AEC parameters may be the parameters that were used to achieve convergence of the AEC for a corresponding microphone lobe, as described herein. In other embodiments, the converged AEC parameters may be parameters used to achieve convergence of the AEC for other beamformed audio pick-up locations, for example, as described herein with respect to FIGS. 6 and 7.

Step 404 may also include storing each of the plurality of AEC parameters in association with the corresponding location information (e.g., the location of the corresponding microphone lobe, the corresponding talker location, etc.). Each AEC parameter may represent an acoustic property of a location towards which the corresponding microphone lobe is deployed, or audio beamforming is otherwise focused. For example, the AEC parameters may include a least means square (“LMS”) coefficient, normalized LMS coefficient (“NLMS”), recursive least squares coefficient (“RLS”), and/or any other suitable filter coefficient, parameters of another gradient-descent based algorithm, a non-linear processing (“NLP”) level, and/or any other parameter that may be used to configure the AEC.

In some embodiments, generating the database at step 404 also includes storing a convergence timestamp in association with each AEC parameter. The convergence timestamp may indicate the time at which the converged AEC parameter was received at the database, the time at which AEC convergence was achieved for the particular microphone lobe, or other timing information associated with the corresponding AEC parameter.

In some embodiments, step 404 may be carried out during a setup phase of the audio system in order to populate the database prior to normal use of the audio system. For example, test signals may be played to various locations in the environment in order to trigger lobe deployment to those locations, and the converged AEC parameters for each of those lobes may be stored in the database in association with the lobe information and/or location information for the lobe, as described herein.

In some embodiments, the corresponding location information is obtained or determined using the map generated at step 402. For example, step 404 may include receiving, by the at least one processor, an AEC parameter associated with convergence of the AEC for a microphone lobe deployed to a first location; assigning, by the at least one processor, the received AEC parameter to a select one of the location points on the map based on the first location; and storing, in the database, the AEC parameter in association with the point assigned to the AEC parameter, for example, as the corresponding location information for that AEC parameter. In other cases, the AEC parameters received at step 404 may be associated with other beamformed audio pick-up locations on the map generated at step 402 that fall within an audio coverage area associated with the environment, instead of, or in addition to, microphone lobes, as described herein. For the sake of brevity and clarity, the remaining steps of process 400 will be described with reference to microphone lobe locations, but it should be appreciated that the process 400 may also be applied to other beamformed audio pick-up locations within an audio coverage area using at least somewhat similar techniques.

In some embodiments, steps 402 and 404 may be completed before proceeding to step 406, as shown in FIG. 4. In other embodiments, the process 400 may begin at step 406 instead. In such cases, the database of AEC parameters may be generated over time, for example, each time step 418 is performed, or as otherwise described herein. Also in such cases, the process 400 may use techniques other than the mapping tool to determine location coordinates for a given microphone lobe, as described herein. For example, the location information may be provided to the at least one processor as an input (e.g., location input 117 in FIG. 1) from another component of the audio system (e.g., beamformer 110, microphone 102, localization module, etc.).

As shown in FIG. 4, step 406 includes receiving, by the at least one processor, an audio signal (e.g., audio signal 105 in FIG. 1) detected by the microphone (e.g., microphone 102 of FIG. 1), and step 408 includes deploying, by the at least one processor, a microphone lobe towards a first location associated with the detected audio signal. For example, the microphone may deploy the microphone lobe towards the first location after detecting the audio signal at the first location. The lobe may be deployed using a beamformer (e.g., beamformer 110), the microphone, and/or other appropriate component of the audio system 100, as described herein. In embodiments where audio coverage areas are used to identify the closest AEC parameters, step 408 may instead include using other beamforming techniques for focusing audio pick-up by the microphone on a first location associated with the detected audio signal, as will be appreciated.

From step 408, the process 400 may proceed to step 410, which includes obtaining, by the at least one processor, one or more AEC parameters for the first location. In some embodiments, obtaining the one or more AEC parameters at step 410 may include retrieving the one or more AEC parameters from the database generated at step 404 based on the first location. For example, said retrieving may include determining whether the database includes the first location, or a database entry comprising converged AEC parameters that were previously determined for the first location. If the first location is found, the AEC parameters for the first location may be retrieved from the database at step 410. If, on the other hand, the at least one processor determines that the database does not include AEC parameters for the first location, retrieving the one or more AEC parameters from the database based on the first location may include determining a second location that is closest to the first location and is associated with at least one of the plurality of AEC parameters stored in the database; retrieving, from the database, the at least one of the plurality of AEC parameters associated with the second location; and providing the at least one of the plurality of AEC parameters as the one or more AEC parameters associated with the first location.

In some embodiments, the one or more AEC parameters obtained at step 410 may be retrieved from the memory that is in communication with the at least one processor (e.g., instead of the database generated at step 404). In such cases, the AEC parameters and corresponding location information may be stored in the memory, and obtaining the one or more AEC parameters for the first location at step 410 comprises identifying another, or third, location that is closest to the first location; obtaining, from the memory, at least one AEC parameter associated with the third location; and providing, to the AEC, the at least one AEC parameter as the one or more AEC parameters for the first location. For example, the at least one AEC parameter may correspond to a second microphone lobe previously deployed towards the third location. As another example, the at least one AEC parameter may correspond to other beamformed audio pick-up location that is closest to the third location and within a corresponding audio coverage area.

In embodiments where audio coverage areas are used instead of, or in addition to microphone lobes, obtaining the one or more AEC parameters at step 410 may include identifying a group of location points within an audio coverage area associated with the environment; determining a first location point within the group of location points that is closest to the first location; obtaining at least one AEC parameter associated with the first location point; and providing the at least one AEC parameter as the one or more AEC parameters for the first location.

From step 410, the process 400 may continue to step 412, which includes initializing the AEC using the one or more AEC parameters obtained at step 410 by applying the one or more AEC parameters to the AEC. For example, an adaptive filter (e.g., adaptive filter 112 of FIG. 1) included in the AEC may be initialized, or pre-populated, with filter coefficients included in the one or more AEC parameters, as described herein.

As shown in FIG. 4, the process 400 further includes, at step 414, generating, by the at least one processor, an echo-cancelled output signal using the initialized AEC and based on the detected audio signal and a reference signal provided to the AEC. For example, generating the echo-cancelled output signal may comprise calculating an echo estimation signal based on the reference signal, e.g., using the adaptive filter, and subtracting the echo estimation signal from the detected audio signal. In various embodiments, step 414 also includes receiving, by the at least one processor, a far end audio signal from a remote computing device in communication with the audio system; providing, by the at least one processor, the far end audio signal to a loudspeaker (e.g., loudspeaker 104 of FIG. 1) included in the audio system for playback; providing, by the at least one processor, the far end audio signal to the AEC as the reference signal for estimating the echo in the audio signal detected by the microphone; and providing, by the at least one processor, the echo-cancelled output signal to the remote computing device.

From step 414, the process 400 may continue to step 416, where the at least one processor determines a convergence status of the AEC. For example, once the AEC is initialized at step 412 using the previously-converged AEC parameters obtained at step 410, the at least one processor (e.g., control unit 116) may continuously or periodically monitor the convergence status of the AEC to see if convergence has been achieved (e.g., the error signal is minimized), as described herein. If the answer at step 416 is “No,” i.e. the AEC is not yet converged, the process 400 may continue to step 417, where the AEC parameters are updated so as to further minimize the error signal or otherwise move towards convergence (i.e. until the cost function reaches below a given threshold), as described herein. In some cases, step 417 includes adapting the AEC parameters based on incoming audio data, i.e. in real-time, using the techniques described herein. From step 417, the process 400 may loop back to the start of step 414 where a new echo-cancelled output signal is generated using the updated AEC parameters and based on the incoming audio signal and the reference signal provided to the AEC. At step 416, the at least one processor checks the AEC convergence status again, based on the updated echo-cancelled output signal. This loop may continue until the answer at step 416 is “Yes,” i.e. the AEC is converged. Once the AEC is converged, the process 400 continues to step 418, which includes storing, in the memory, a set of AEC parameters corresponding to the convergence status of the AEC. For example, the corresponding AEC parameters (or converged AEC parameters) may be stored in association with the first location of the corresponding microphone lobe in the parameter database, or other location of the memory.

The process 400 may end at step 418 once the converged AEC parameters are stored, or may loop back to step 414 to generate a new echo-cancelled output signal and re-check the convergence status based on any newly received audio data, or otherwise ensure that the echo-cancelled output signal generated at step 414 remains relatively error-free. In some embodiments, the converged AEC parameters (e.g., coefficients) may be stored periodically, or at regular intervals, after convergence is achieved, so that the parameter database is kept up to date with the most recently converged AEC parameters. In other embodiments, the AEC parameters may be stored just before moving the relevant lobe to a new location, so that the stored AEC parameters represent the most recent or latest conditions for that lobe.

FIG. 5 illustrates an exemplary computing device 500, in accordance with embodiments. As shown, the computing device 500 may comprise at least one processor 502, a memory 504, a communication interface 508, and a user interface 510 for carrying out the techniques described herein. The components of the computing device 500 may be communicatively coupled to each other by system bus, network, or other connection mechanism (not shown). In various embodiments, the computing device 500 may be a personal computer (PC), a laptop computer, a tablet, a smartphone or other smart device, other mobile device, thin client, a server, or other computing platform. In such cases, the computing device 500 may further include other components commonly found in a PC or laptop computer, such as, e.g., a data storage device, a native, or built-in, microphone device, and a native audio speaker device. In some embodiments, the computing device 500 is a standalone computing device, such as, e.g., the computing device 106 shown in FIG. 1, or other separate device of the audio system 100. In other embodiments, the computing device 500 resides in another component of the audio system 100, such as, e.g., the microphone 102 or an audio device that also includes the loudspeaker 104 and/or the microphone 102. In some embodiments, the computing device 500 may be physically located in and/or dedicated to the given environment or room, for example, as shown in FIG. 1. In other embodiments, the computing device 500 resides in an external network, such as a cloud computing network, or is otherwise distributed in a cloud-based environment. In some embodiments, the computing device 500 may be implemented with firmware or completely software-based as part of a network, which may be accessed or otherwise communicated with via another device, including other computing devices, such as, e.g., desktops, laptops, mobile devices, tablets, smart devices, etc.

Processor 502 executes instructions retrieved from the memory 504. In embodiments, the memory 504 stores one or more software programs, or sets of instructions, that embody the techniques described herein. When executed by the processor 502, the instructions may cause the computing device 500 to implement or operate all or parts of the techniques described herein, one or more components of the audio system 100, and/or methods, processes, or operations associated therewith, such as, e.g., process 400 shown in FIG. 4. As shown in FIG. 5, the memory 504 may also include a mapping tool 512 that is configured to cause the computing device 500, or the at least one processor 502 included therein, to generate a map, grid, or other graphical representation of an environment, as described herein.

In general, the computing device 500 may be configured to control and communicate or interface with the other hardware devices included in the audio system 100, such as the microphone 102, the loudspeaker 104, and any other devices in the same network. The computing device 500 may also control or interface with certain software components of the audio system 100. For example, the computing device 500 may interface with a localization module (not shown) installed or included in the microphone 102, the beamformer 110, and/or other component of the audio system, in order to receive sound localization coordinates or other location data for an audio source detected by the microphone 102. In addition, the computing device 500 may be configured to communicate or interface with external components coupled to the audio system 100 (e.g., remote servers, databases, and other devices). For example, the computing device 500 may interface with a component graphical user interface (GUI or CUI) associated with the audio system 100, any existing or proprietary conferencing software, and/or a remote computing device located at the remote location (or far end). In addition, the computing device 500 may support one or more third-party controllers and in-room control panels (e.g., volume control, mute, etc.) for controlling one or more of the audio devices in the audio system 100.

Communication interface 508 may be configured to allow the computing device 500 to communicate with one or more devices (or systems) according to one or more protocols. In some embodiments, the communication interface 508 includes one or more wired communication interfaces, such as, for example, an Ethernet port, a high-definition serial-digital-interface (HD-SDI), an audio network interface with universal serial bus (ANI-USB), a high definition media interface (HDMI) port, a USB port, or an audio port (e.g., a 3.5 mm jack, lightning port, etc.). In some embodiments, the communication interface 508 includes one or more wireless communication interfaces, such as, for example, a broadband cellular communication module (e.g., to support 4G technology, 5G technology, or the like), a short-range wireless communication module (e.g., to support Bluetooth technology, Radio Frequency Identification (RFID) technology, Near Field Communication (NFC) technology, or the like), a long-range wireless communication module (e.g., to support Wi-Fi technology or other Internet connection), or any other type of wireless communication module. In some embodiments, communication interface 508 may enable the computing device 500 to transmit information to, and receive information from, one or more of the loudspeaker 104, the microphone 102, or other component(s) of the audio system 100. Such information may include, for example, location data (e.g., sound localization coordinates), audio coverage area assignments and parameters (or boundaries), lobe information (e.g., directionality, lobe width, and/or other pick-up pattern information), and more.

User interface 510 may facilitate interaction with a user of the computing device 500 and/or audio system 100. As such, the user interface 510 may include input components such as a keyboard, a keypad, a mouse, a touch-sensitive panel, a microphone, and a camera, and output components such as a display screen (which, for example, may be combined with a touch-sensitive panel), a sound speaker, and a haptic feedback system. The user interface 510 may also comprise devices that communicate with inputs or outputs, such as a short-range transceiver (RFID, Bluetooth, etc.), a telephonic interface, a cellular communication port, a router, or other types of network communication equipment. The user interface 510 may be internal to the computing device 500, or may be external and connected wirelessly or via connection cable, such as through a universal serial bus port. In some embodiments, the user interface 510 may include a button, touchscreen, or other input device for receiving a user input associated with movement of a microphone lobe, placement of a new microphone lobe, and the like, and/or a user input associated with indicating the start or end of a set-up mode or phase of the audio system 100 and/or the start or end of a normal use mode or phase of the audio system 100, as described herein.

Any of the processors described herein, such as, e.g., processor 502, may include a general purpose processor (e.g., a microprocessor) and/or a special purpose processor (e.g., an audio processor, a digital signal processor, etc.). In some examples, processor 502, and/or any other processor described herein, may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs).

Any of the memories or memory devices described herein, such as, e.g., memory 504, may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 504, and/or any other memory described herein, includes multiple kinds of memory, particularly volatile memory and non-volatile memory.

Moreover, any of the memories described herein (e.g., memory 504) may be computer readable media on which one or more sets of instructions, such as the software for operating the techniques described herein, can be embedded. The instructions may reside completely, or at least partially, within any one or more of the memory, the computer readable medium, and/or within one or more processors (e.g., processor 502) during execution of the instructions. In some embodiments, memory 504, and/or any other memory described herein, may include one or more data storage devices configured for implementation of a persistent storage for data that needs to be stored and recalled by the end user, such as, e.g., location data received from one or more audio devices, prestored location data or coordinates indicating a known location of one or more audio devices, and more. In such cases, the data storage device(s) may save data in flash memory or other memory devices. In some embodiments, the data storage device(s) can be implemented using, for example, SQLite data base, UnQLite, Berkeley DB, BangDB, or the like.

In some embodiments, any of the computing devices described herein, such as, e.g., the computing device 200, may include one or more components configured to facilitate a conference call, meeting, classroom, or other event and/or process audio signals associated therewith to improve an audio quality of the event. For example, in various embodiments, the computing device 500, and/or any other computing device described herein, may comprise a digital signal processor (“DSP”) configured to process the audio signals received from the various audio sources using, for example, automatic mixing, matrix mixing, delay, compressor, parametric equalizer (“PEQ”) functionalities, acoustic echo cancellation, and more. In other embodiments, the DSP may be a standalone device operatively coupled or connected to the computing device using a wired or wireless connection. One exemplary embodiment of the DSP, when implemented in hardware, is the P300 IntelliMix Audio Conferencing Processor from SHURE, the user manual for which is incorporated by reference in its entirety herein. As further explained in the P300 manual, this audio conferencing processor includes algorithms optimized for audio/video conferencing applications and for providing a high quality audio experience, including eight channels of acoustic echo cancellation, noise reduction and automatic gain control. Another exemplary embodiment of the DSP, when implemented in software, is the IntelliMix Room from SHURE, the user guide for which is incorporated by reference in its entirety herein. As further explained in the IntelliMix Room user guide, this DSP software is configured to optimize the performance of networked microphones with audio and video conferencing software and is designed to run on the same computer as the conferencing software. In other embodiments, other types of audio processors, digital signal processors, and/or DSP software components may be used to carry out one or more of audio processing techniques described herein, as will be appreciated.

Moreover, the computing device 500, and/or any of the other computing devices described herein, may also comprise various other software modules or applications (not shown) configured to facilitate and/or control the conferencing event, such as, for example, internal or proprietary conferencing software and/or third-party conferencing software (e.g., Microsoft Skype, Microsoft Teams, Bluejeans, Cisco WebEx, GoToMeeting, Zoom, Join.me, etc.). Such software applications may be stored in the memory (e.g., memory 504) of the computing device and/or may be stored on a remote server (e.g., on premises or as part of a cloud computing network) and accessed by the computing device via a network connection. Some software applications may be configured as a distributed cloud-based software with one or more portions of the application residing in the computing device (e.g., computing device 500) and one or more other portions residing in a cloud computing network. One or more of the software applications may reside in an external network, such as a cloud computing network. In some embodiments, access to one or more of the software applications may be via a web-portal architecture, or otherwise provided as Software as a Service (SaaS).

It should be understood that examples disclosed herein may refer to computing devices and/or systems having components that may or may not be physically located in proximity to each other. Certain embodiments may take the form of cloud based systems or devices, and the term “computing device” should be understood to include distributed systems and devices (such as those based on the cloud), as well as software, firmware, and other components configured to carry out one or more of the functions described herein. Further, as noted above, one or more features of the computing device may be physically remote (e.g., a standalone microphone) and may be communicatively coupled to the computing device.

In general, a computer program product in accordance with embodiments described herein includes a computer usable storage medium (e.g., standard random access memory (RAM), an optical disc, a universal serial bus (USB) drive, or the like) having computer-readable program code embodied therein, wherein the computer-readable program code is adapted to be executed by a processor (e.g., working in connection with an operating system) to implement the methods described herein. In this regard, the program code may be implemented in any desired language, and may be implemented as machine code, assembly code, byte code, interpretable source code or the like (e.g., via C, C++, Java, ActionScript, Python, Objective-C, JavaScript, CSS, XML, and/or others). In some embodiments, the program code may be a computer program stored on a non-transitory computer readable medium that is executable by a processor of the relevant device.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

Any process descriptions or blocks in the figures, such as, e.g., FIG. 4, should be understood as representing modules, segments, or portions of code that include one or more executable instructions for implementing specific logical functions or steps in the process, and alternate implementations are included within the scope of the embodiments described herein, in which functions may be executed out of order from that shown or discussed, including substantially concurrently or in reverse order, depending on the functionality involved, as would be understood by those having ordinary skill in the art.

Further, it should be noted that in the description and drawings, like or substantially similar elements may be labeled with the same reference numerals. However, sometimes these elements may be labeled with differing numbers, such as, for example, in cases where such labeling facilitates a more clear description. In addition, system components can be variously arranged, as is known in the art. Also, the drawings set forth herein are not necessarily drawn to scale, and in some instances, proportions may be exaggerated to more clearly depict certain features and/or related elements may be omitted to emphasize and clearly illustrate the novel features described herein. Such labeling and drawing practices do not necessarily implicate an underlying substantive purpose. The above description is intended to be taken as a whole and interpreted in accordance with the principles taught herein and understood to one of ordinary skill in the art.

In this disclosure, the use of the disjunctive is intended to include the conjunctive. The use of definite or indefinite articles is not intended to indicate cardinality. In particular, a reference to “the” object or “a” and “an” object is intended to also denote one of a possible plurality of such objects.

Moreover, this disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, which may be amended during the pendency of the application for patent, and all equivalents thereof, when interpreted in accordance with the breadth to which they are fairly, legally and equitably entitled.

What is claimed is:

1. A method of reducing echo in an audio system comprising a microphone, an acoustic echo canceller (AEC), and at least one processor, the method comprising:
receiving, by the at least one processor, an audio signal detected by the microphone;
deploying, by the at least one processor, a microphone lobe towards a first location associated with the detected audio signal;
obtaining, by the at least one processor, one or more AEC parameters for the first location, the one or more AEC parameters being stored in a memory in communication with the at least one processor;
initializing, by the at least one processor, the AEC using the one or more AEC parameters; and
generating, by the at least one processor, an echo-cancelled output signal using the initialized AEC and based on the detected audio signal and a reference signal provided to the AEC.

2. The method of claim 1, further comprising:
receiving, by the at least one processor, a plurality of AEC parameters, each AEC parameter associated with convergence of the AEC for a select one of a plurality of microphone lobes;
receiving, by the at least one processor, location information for each of the plurality of microphone lobes;
storing, in a database included in the memory, each of the plurality of AEC parameters in association with the corresponding location information,
wherein obtaining the one or more AEC parameters comprises: retrieving the one or more AEC parameters from the database based on the first location.

3. The method of claim 2, further comprising: storing, in the database, a convergence timestamp in association with each AEC parameter.

4. The method of claim 2, further comprising:
generating, by the at least one processor, a map of an environment comprising the audio system;
assigning, by the at least one processor, each of the plurality of AEC parameters to a select point on the map based on the location information corresponding to that AEC parameter; and
storing, in the database, the point assigned to each AEC parameter as the corresponding location information for that AEC parameter.

5. The method of claim 4, wherein retrieving the one or more AEC parameters from the database based on the first location comprises:
determining a second location that is closest to the first location and is associated with at least one of the plurality of AEC parameters stored in the database;
retrieving, from the database, the at least one of the plurality of AEC parameters associated with the second location; and
providing the at least one of the plurality of AEC parameters as the one or more AEC parameters associated with the first location.

6. The method of claim 1, wherein obtaining the one or more AEC parameters for the first location comprises:
identifying a third location that is closest to the first location;
obtaining, from the memory, at least one AEC parameter associated with the third location; and
providing, to the AEC, the at least one AEC parameter as the one or more AEC parameters for the first location.

7. The method of claim 6, wherein the at least one AEC parameter corresponds to a second microphone lobe previously deployed towards the third location.

8. The method of claim 1, further comprising:
determining, by the at least one processor, a convergence status of the AEC; and
storing, in the memory, a set of AEC parameters corresponding to the convergence status of the AEC, the set of AEC parameters being stored in association with the first location.

9. The method of claim 1, wherein the one or more AEC parameters include at least one of a filter coefficient or a non-linear processing level.

10. The method of claim 1, further comprising:
receiving, by the at least one processor, a far end audio signal from a remote computing device in communication with the audio system;
providing, by the at least one processor, the far end audio signal to a loudspeaker included in the audio system for playback;
providing, by the at least one processor, the far end audio signal to the AEC as the reference signal for estimating the echo in the audio signal detected by the microphone; and
providing, by the at least one processor, the echo-cancelled output signal to the remote computing device.

11. The method of claim 1, wherein generating the echo-cancelled output signal comprises: calculating an echo estimation signal based on the reference signal, and subtracting the echo estimation signal from the detected audio signal.

12. An audio system, comprising:
a loudspeaker configured to play a far end audio signal received from a remote computing device;
a microphone configured to detect a near end audio signal;
an acoustic echo canceller (AEC) configured to receive the far end audio signal as a reference signal for estimating an echo in the near end audio signal;
a memory configured to store a plurality of AEC parameters for configuring the AEC; and
at least one processor in communication with the remote computing device and configured to:
receive the near end audio signal from the microphone;
deploy a microphone lobe towards a first location associated with the near end audio signal;
obtain one or more AEC parameters for the first location;
initialize the AEC using the one or more AEC parameters; and
generate an echo-cancelled output signal using the initialized AEC and based on the near end audio signal and the reference signal.

13. The audio system of claim 12, wherein the at least one processor is configured to obtain the one or more AEC parameters for the first location by: identifying a second location that is closest to the first location; retrieving, from the memory, at least one AEC parameter associated with the second location; and providing, to the AEC, the at least one AEC parameter as the one or more AEC parameters for the first location.

14. The audio system of claim 13, wherein the at least one AEC parameter corresponds to a second microphone lobe previously deployed towards the second location.

15. The audio system of claim 12, wherein the at least one processor is further configured to:
determine a convergence status of the AEC; and
store, in the memory, a set of AEC parameters corresponding to the convergence status of the AEC, the set of AEC parameters being stored in the memory in association with the first location.

16. The audio system of claim 12, wherein the at least one processor is configured to generate the echo-cancelled output signal by: calculating an echo estimation signal based on the reference signal, and subtracting the echo estimation signal from the near end audio signal.

17. A method of generating a database of acoustic echo cancellation (“AEC”) parameters for an environment, the method comprising:
generating, by at least one processor, a map of the environment, the map comprising a plurality of location points;
receiving, by the at least one processor, an AEC parameter associated with convergence of an acoustic echo canceller for a microphone lobe deployed to a first location;
assigning, by the at least one processor, the AEC parameter to a select one of the plurality of location points based on the first location; and
storing, in a memory, the AEC parameter in association with the assigned location point.

18. The method of claim 17, further comprising: storing, in the memory, a convergence timestamp in association with the AEC parameter.

19. The method of claim 17, further comprising: selecting the plurality of location points based on one or more audio coverage areas associated with the environment.

20. The method of claim 17, wherein the AEC parameter includes at least one of a filter coefficient or a non-linear processing level.
